(19) United States
(12) Patent Application Publication
(10) Pub. No.: US 2005/0144324 A1
(43) Pub. Date: Jun. 30, 2005

(54) Service for analyzing web client dialogs

(75) Inventors: David A. George, Somers, NY (US); Malgorzata E. Stys, Yorktown Heights, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/728,864

(22) Filed: Dec. 8, 2003

(51) Int. Cl. G06F 15/16

(52) U.S. Cl. 709/246

(57) ABSTRACT

A method (and structure) of method of enhancing a dialog with a web server includes determining a dialog state by comprehensively capturing a two-way dialog with the web server

### CROSS-REFERENCE TO RELATED APPLICATIONS

The following copending Application, assigned to the present assignee, is related to the present Application and is incorporated herein by reference:

U.S. patent application Ser. No. ______, filed on ______, to George et al., entitled “METHOD AND STRUCTURE TO ANALYZE WEB CLIENT DIALOGS”, having IBM Docket YOR920030318US1.

### BACKGROUND OF THE INVENTION

1. Field of the Invention

The present invention generally relates to user web browser environments and, more particularly, to techniques for providing capture of user interaction and feedback. More specifically, initial access to a web page causes all subsequent traffic related to the initial web page access to be routed via a proxy/surrogate server, thereby allowing the two-way capture of all requests arriving from the requester's browser and of all responses being returned to the browser. This two-way dialog capture capability, along with a capability to modify and enhance the dialog has potentially numerous commercial applications related to web sites, particularly in view of its capability of capturing meandering to other web sites related to the dialog.

2. Description of the Related Art

As the World Wide Web matures, it is becoming increasingly important to provide methods to assure that web pages and web dialogs are measurably adequate for their intended purpose. Generally, a web site is designed and then intensely reviewed by a collection of individuals who visit the web site and provide design feedback on a survey questionnaire. The review is intended to determine whether the web site effectively facilitates the search for information on the web site. This approach is adequate for static content and even many forms of dynamic content web pages.

However, new dynamic content is beginning to be deployed that challenges the limited review or sampling. Methods of natural language processing (NLP) and artificial intelligence dramatically increase the challenge of evaluating web site effectiveness.

For example, NLP techniques allow a user to type in a query using a free form sentence or paragraph format, and the search will be conducted based on the “conceptualization” of the free form query format. For details on NLP techniques, the following texts are suggested: 1) Chris Manning and Hinrich Schtze, Foundations of statistical Natural Language Processing, MIT Press. Cambridge, Mass.: May 1999; or 2) Allen, James (1995) Natural Language Understanding. Redwood City, Calif.: Benjamin/Cummings Publishing Co., Inc.

It is assumed in the following discussion that the connection from the client browser to at least one remote server is provided via an Internet connection. A current primary protocol for such connection is TCP/IP.

Herein, the message flow from browser to server is referred to as a “request”, and the message flow from the server to browser is referred to as a “response”. Also, the terms “user” and “client” are used to refer to the individual and browser apparatus normally associated with the “human side” of the arrangement.

For ordinary web server customization, it is usually sufficient to conduct studies wherein the subject user follows a prescribed set of tasks using a web browser to a test site. Generally, the usefulness and suitability of the server side is collected via client interview and review of host logs. This methodology generally breaks down in the realm of natural language interaction for a variety of reasons, including:
the time due to system responses is not reliable from the server end only and is further exasperated by network effects;
the user might be performing multiple transactions with the same server or a mix of web sites, including those that might invalidate testing observations (such as “think time”). Thus, the server-side-only observation could appear bizarre or incoherent;
in natural language studies, it is usually necessary to modify the server response stream with additional annotated data, e.g., additional menus, provisioning with wizards, other language translation, providing addition languages or terminology, and providing accessibility options, such as in-stream multimedia; and
the user interview should be conducted “in-situ”, not after the experiment when the subject hurries through a questionnaire.

With the newer capabilities of dynamic content, natural language processing, and artificial intelligence, it is increasingly important to be able to measure the effectiveness of client dialogs and to be able to adapt the web responses to the particular situation. Static and dynamic content web pages provide adaptation to a framework of anticipated needs for general users, but cannot adapt to the whim of a particular user in a particular mood. Prior to the present invention, there have been no methods to implement such measurement and to provide an apparatus that would provide a distinctive service for customers that need to improve all forms of web content.

Therefore, a need exists to be able to capture the entire dialog directed to a web server, including those portions of the dialog that are not currently captured by server-side-only techniques, to be able to determine a context of the dialog, and to be able to modify the contents, as based on being able to capture the two-way dialog.

### SUMMARY OF THE INVENTION

In view of the foregoing and other exemplary problems, drawbacks, and disadvantages of the conventional techniques, it is an exemplary feature of the present invention to provide an exemplary structure and method for capturing the dialog initiated by an initial access request to a network node such as a web server, as a comprehensive two-way dialog, including both the requests arriving from a user's browser as well as the responses returning to the browser from the web server, rather than an incomplete dialog having dialog holes.

It is another exemplary feature of the present invention to be able to capture dialog in environments of natural language processing (NLP) and artificial intelligence techniques and provide a method to evaluate web site effectiveness in these environments.

It is another exemplary feature of the present invention to be able to dynamically modify the contents of a dialog, as based upon having detected a perceived state of a user and system in the dialog.

It is another exemplary feature of the present invention to capture the whole psychological aspect of a web site dialog, as well as the fact of the interactions.

It is another exemplary feature of the present invention to be able to remain in the middle of a dialog stream for capture of page visits outside the originally-contacted system, thereby providing a means of capturing the requester's meanderings as the dialog proceeds.

It is another exemplary feature of the present invention to log a web-server dialog for advanced analysis and for improving an effectiveness of the web site.

It is another exemplary feature of the present invention to provide a method of web server dialog capture that can be used in many commercial applications that can benefit by the present invention's capability to capture a comprehensive two-way dialog and that can enhance a content of the dialog by modifying contents of the dialog data stream.

Therefore, in a first exemplary aspect of the present invention, described herein is a method of enhancing a dialog with a web server, including determining a dialog state by comprehensively capturing a dialog with the web server.

In a second exemplary aspect of the present invention, also described herein is an apparatus for enhancing a dialog with a web server, including a dialog capture module to comprehensively capture a dialog between the web server and a browser.

In a third exemplary aspect of the present invention, also described herein is a signal-bearing medium tangibly embodying a program of machine-readable instructions executable by a digital processing apparatus to perform a method of enhancing a dialog with a web server, the method including comprehensively capturing a dialog between the web server and a browser.

In a fourth exemplary aspect of the present invention, also described herein is a method of providing a service, including at least one of: operating an intermediary web service to comprehensively capture a dialog with a web site, wherein the dialog is captured when an initial access request from a browser is received by the web site and a subsequent dialog between the web site and the browser is directed through the intermediary web service; operating a web site that requests the intermediary web service to capture the dialog; analyzing information in the dialog; modifying a content of the dialog; designing a computer program module to be incorporated in the intermediary web service for the dialog capturing; designing a computer program module to be used in the analyzing; and designing a computer program module to be used in the modifying content of the dialog.

In a fifth exemplary aspect of the present invention, also described herein is a system for capturing a dialog with a web server, including means for receiving, from a browser, an initial access request to the web server; means for comprehensively capturing a dialog between the browser and the web server based on the initial access request, wherein the capturing includes capturing an inbound request from the browser and an outbound response from the web server in response to the inbound request.

In a sixth exemplary aspect of the present invention, also described herein is a method of providing a service, the method including at least one of: operating a web server so that, upon receiving an initial access request to the web server, a subsequent dialog associated with the initial access is directed through an intermediary established to capture the dialog; operating a web server in the manner of the intermediary; at least one of developing, producing, selling, transmitting via the web server, and receiving, via a network, a set of machine-readable instructions executable by a digital processing apparatus to perform a method of capturing a dialog on the network using the intermediary; at least one of developing, producing, selling, transmitting via the network, and receiving via the network a set of machine-readable instructions executable by a digital processing apparatus to perform a method of at least one of filtering and modifying a dialog being processed through the intermediary; at least one of receiving, displaying, storing, analyzing, and receiving an analysis of a dialog captured using the intermediary; at least one of developing, producing, selling, transmitting via the network, receiving via the network, and executing a set of machine-readable instructions executable by a digital processing apparatus to at least one of receive, display, store, and analyze a dialog captured using the intermediary.

In a seventh exemplary aspect of the present invention, also described herein is a method of enhancing a dialog with a web server, including comprehensively capturing a dialog with the web server.

The present invention provides a method to comprehensively capture the dialog between a browser and the web site, including meandering of visits to other web sites, and to dynamically enhance the dialog, as based on having been able to capture the dialog in this comprehensive manner. Conventional methods of monitoring web site traffic do not have the capability to capture this two-way traffic and do not have the capability of capturing dialogs with other, non-related web sites.

### BRIEF DESCRIPTION OF THE DRAWINGS

The foregoing and other exemplary purposes, features, aspects and advantages will be better understood from the following detailed description of an exemplary embodiment of the invention with reference to the drawings, in which:

FIG. 1 is a block diagram 100 that illustrates an exemplary typical computing environment in which at least one client browser connects to at least one web server using customary Internet Service Provider (ISP) techniques that might include the interdiction of a proxy server (similar to an exemplary embodiment of the present invention), wherein logging of use is limited and is only performed on the web server side of the web site dialog;

FIG. 2 is a block diagram 200 illustrating a client-side conventional perspective for in-house testing for web effectiveness, wherein the web browser and associated pop-up browser dialog traffic is captured in a log file;

FIG. 3 is a representation 300 illustrating conventional testing means for automated analysis and evaluation of web dialogs;

FIG. 4 is a block diagram 400 illustrating an exemplary apparatus 404 for implementing the capture and modification of request and response streams in a client-to-server environment, in accordance with an exemplary embodiment of the present invention;

FIG. 5 is a block diagram 500 illustrating an exemplary method for background monitoring, analyzing and reporting, as might be used in the present invention;

FIG. 6 is an exemplary listing 600 of typical logging contents of conventional logging;

FIG. 6A is an exemplary listing 601 of typical logging contents as exemplarily used for the present invention;

FIG. 7 is an exemplary implementation 700 of a “Request Filtering” module 408;

FIG. 8 is an exemplary implementation 800 of a “Request Modification” module 409;

FIG. 9 is an exemplary implementation 900 of a “Response Filtering” module 414;

FIG. 10 is an exemplary implementation 1000 of a “Response Modification” module 415;

FIG. 11 illustrates an exemplary hardware/information handling system 1100 for incorporating the present invention therein; and

FIG. 12 illustrates a signal bearing medium 1200 (e.g., storage medium) for storing steps of a program of a method according to the present invention.

### DETAILED DESCRIPTION OF EXEMPLARY EMBODIMENTS OF THE INVENTION

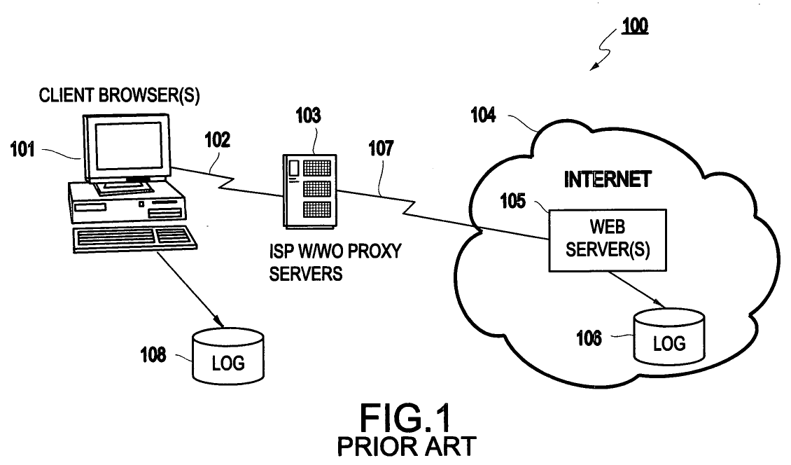

Referring now to the drawings, and more particularly to FIGS. 1-12, exemplary embodiments of the present invention will now be described. The present invention provides dynamic and scalable techniques for redirecting a browser-to-server dialog through an apparatus that permits capture of all request and response streams comprising the dialog that ensues between at least one user's browser and at least one remote server.

Therefore, because it captures both directions of the web site dialog, the present invention makes possible the collection of relevant user browser-to-server dialogs in a form that captures substantially the whole (and more preferably the complete) psychological aspect, as well as the fact of logged interactions. That is, the “holes” in the dialog of conventional methods are filled in by the present invention, so that the capture truly reflects the “state” of the user.

In addition to the two-way dialog capture capability, an exemplary embodiment of the present invention includes an apparatus that additionally can modify in various ways both the request stream and the response stream for web transactions, such as visiting non-encrypted web pages with any content, a logging system for recording the dialog, and a system for reporting, viewing, and/or analyzing the measures resulting from having observed the dialog with the web site.

As will be explained, this capability for modifying the dialog contents will be significant, not only for the purpose of experiment scenarios that measure and improve web site effectiveness, but also has tremendous potential commercial applications, particularly when understood as the capability of being able to determine the state of the user conducting web site dialog, including aspects of the user's psychological state.

The basic apparatus of the present invention, originally prototyped using the assignee's Web Intermediaries (WBI®) component (www.alphaworks.com), captures dialog streams, and, through dynamic analysis, modifies the appropriate streams. Intermediaries are computational entities, developed by the assignee, that can be positioned anywhere along an information stream and are programmed to tailor, customize, personalize, or otherwise enhance data as it flows along the stream.

Therefore, WBI® provides the infrastructure to intercept the request and response streams of the present invention. Once the user's browser has opened an associated web site, even visits to non-site pages (e.g., that are selected from provided on-page links) allows the capture apparatus to remain in the middle of the streams. Thus, the present invention provides for dialog capture of page visits outside the originally-contacted system, thereby providing a dialog capture capability not previously possible. This capability is one aspect of the feature of the present invention in which the state of the user is captured because substantially the whole dialog is accessible to the present invention, including meanderings to other web sites, a capability not previously known in the art.

As explained in more detail below, this capability is possible because the apparatus of the present invention has the capability to modify URLs requested by the user browser and returned back to the user browser, such that the URL traffic is routed through the intermediary apparatus of the present invention.

Dynamic application of the knowledge of the user's page visits adds a special insight to the user's interest at that moment and can be used to modify the response stream to better adapt to the whim of the user. Modifications may introduce more or less technical annotations to existing web pages, insert specific annotations for advertising, and request user feedback. The method can include dynamic modification of a web page or provide pop-ups with completely new content. Exemplary commercial applications of this modification capability is discussed in more detail below.

“Dynamic modification” refers to the ability to contextualize current requests “on the fly”, thereby customizing them in accord with prior interactions and the user input. Pop-ups provide one method for dynamically requesting user feedback (e.g., during an experimental evaluation), while relevant information is fresh in the mind of the client.

It was noted during initial experimentation by the inventors that popups and questionnaires that were conducted after the dialog was complete were not nearly as effective, because of focus and memory issues, in determining the state of mind of the user during the dialog.

The logging system creates a basis for system review and analysis and, ultimately, for deriving success criteria of natural language dialogs. It also enhances the capability of estimating business impact of NLP applications.

Prior user studies testing the usability of natural-language-enabled, dialog-based, information access systems demonstrated the need for this innovation. In a user study done by the present inventors, the usability of the prototype system was objectively evaluated by consumers in an effort to better understand the users' needs, so as to pinpoint improvements and enhancements to the system, as based on the findings.

Specifically, when a new system is compared with existing systems, it would be ideal to design a user study which would reveal how much more or less successful the prototype system meets the users' expectations (e.g., system flow, ease of use, validity of the system response, and user vocabulary), in comparison to existing methods and systems.

In a series of comparative user studies designed to test the NLP-driven dialog transactional system supported by the present invention, an exemplary objective was to bring out the usability differences between a natural-language dialog, a menu-driven system, earlier generations of questionnaire-based directed dialog systems, or simple free browsing. To achieve this exemplary objective, quantitative measurements had to be taken of the various types of dialogs.

For example, in one experiment, for consistency, each user was presented with the same task (e.g., selecting and buying a Thinkpad®) and was instructed to start from a pre-defined website (e.g., initial screen of the dialog assistant, initial page of the menu-driven system).

Although the sequence of presented systems was randomized, the users were constrained to make their purchase starting with a pre-specified interface. This setup was artificial, since a typical web buying experience is not predetermined by several predetermined browsing points. In an effort to make the study more real or realistic, and to mirror a typical sitting-in-a-living-room web-buying experience, the users were provided an in-situ mechanism allowing them to follow their own gut instinct browsing habits.

Therefore, in this experiment, the success of the exemplary web-buying experience was measured in a more objective fashion, in which it could be observed how many users would voluntarily hit the dialog system link and what actions they would subsequently take. The method provided a more natural make-your-own-browsing-choice in-situ mechanism for testing the efficiency of web-based systems.

The following description illustrates an exemplary aspect of the present invention that is based on this method of experiment, using an exemplary computer networking environment. It should be understood, however, that the invention is not limited to use with any particular network environment and is, instead, more generally applicable for use with any environment in which accessing a web service via a web browser is provided. Furthermore, the invention is not limited to the number of users, browsers, Internet connections (ISPs), inclusion of proxies, and web servers.

As used herein, the term “browser” generally refers to a software program(s) that may be invoked to perform access of web page content. Although some browsers may be restricted as to the content that might be accessed, the invention is not limited to any particular browser application or browser capabilities.

It is also realized that the teachings of the present invention may find application in accordance with simple data and survey capture for the purpose of evaluating web pages. In other environments the present invention may be deployed to track the user's interest (mood) and, thereby, provide modifications to the response stream, as appropriately based on tracking the user's interests. This capability of the present invention to adapt to the user's perceived interest (e.g., “state”) is particularly useful in potential commercial aspects of the present invention, to be discussed in more detail below.

It should also be noted that the invention is not limited to simply modifying the response stream to get an effective result. The original request stream may also be modified as deemed appropriate in circumstances. In such cases, the invention is seen as providing two distinct basic capabilities: 1) measurement, and 2) dynamic adaptation (e.g., ability to dynamically modify content of the dialog). Each of these two capabilities is equally important in describing the technical capabilities of the present invention.

To better explain and contrast the benefits and techniques of the present invention, FIG. 1 depicts a conventional system 100 including at least one client browser 101, such as a computer system, running a typical instance of an Internet browser application. The browser 101 connects to the Internet 104 through an Internet Service Provider 102, 103, 107. The method for connection may vary, including the possible use of proxy servers, but these are not exclusionary to means of the present invention. In a typical use, at least one web server 105 is accessed.

In this conventional system 100, some logging of user visits and interactions are optionally captured 106 for exclusionary use by the web site provider.

A disadvantage of this conventional system 100 is that, in an evaluation, the burden of dialog capture falls into the web server 106. Any visit to alternate web servers will not be captured in the same log, thus compounding the problem to assemble the context of a user's session with a target web server. Therefore, since the whole dialog is not captured, the dialog is incomplete, provides inconclusive results, and may be quite bewildering to someone attempting to analyze the user's dialog during the session.

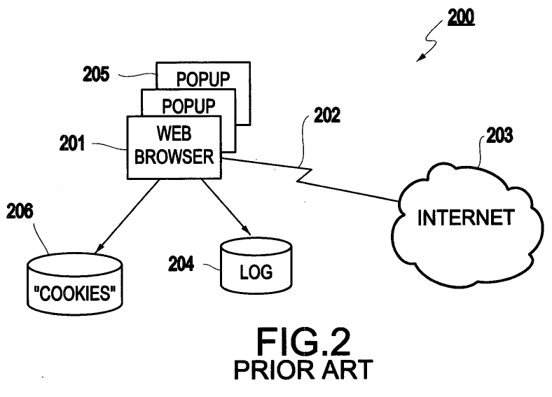

FIG. 2 provides extra detail 200 of the client side, illustrating that in the course of a dialog, the browser 201 might launch additional browsers or popups 205 while connected to the Internet 202, 203. Some web site evaluations can be more informational if the test subjects have a logging capability 204 enabled with their web browsers.

In the prior art, one also finds application of “cookies” 206 to benefit dynamic web page content, as well as server-side data collection. Such monitoring benefits can enhance the overall understanding of collected test data, but it is still limited to only that for a specific server and fails to provide monitoring of the entire dialog.

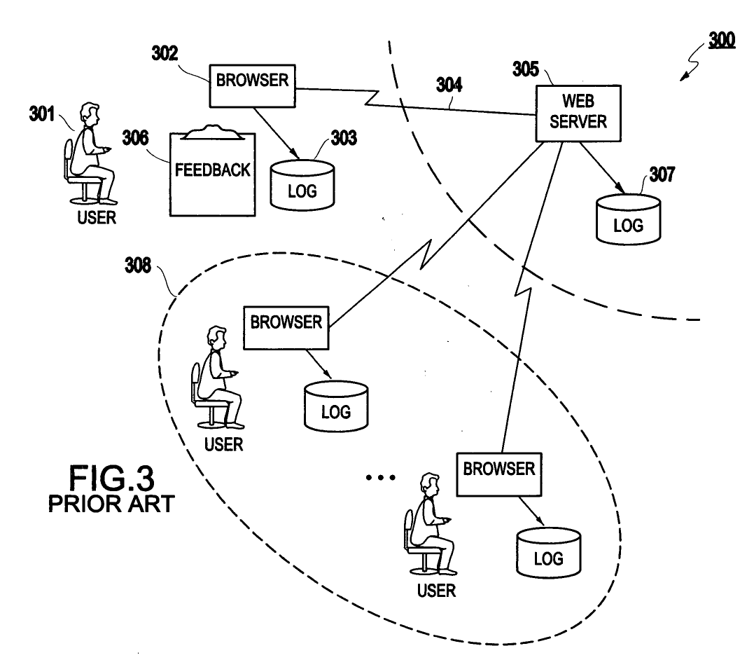

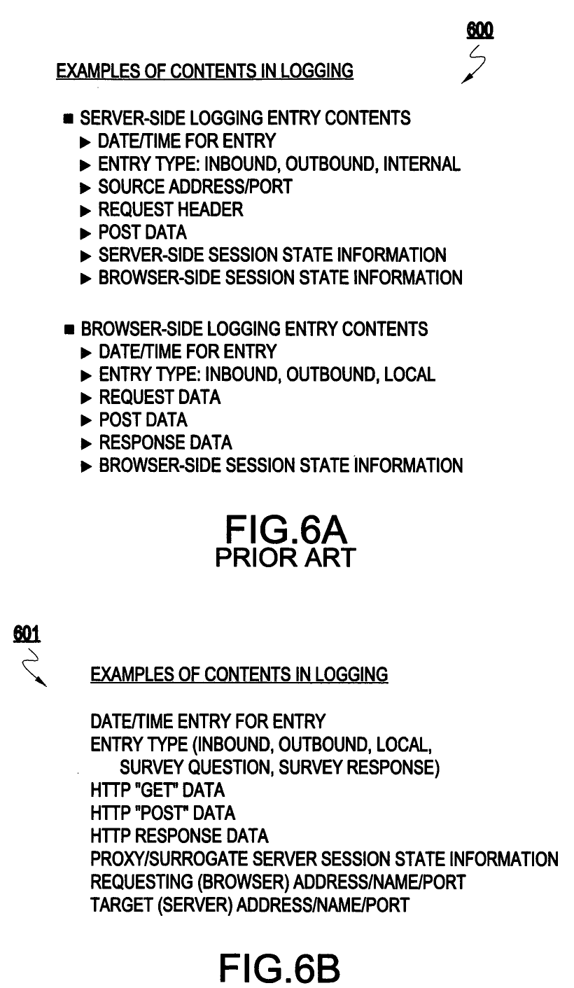

FIG. 3 shows a typical conventional testing session 300 comprising logging and evaluation of a web site. Logging includes listed contents, as exemplarily shown in the table of FIG. 6. It is noted here that the present invention also includes the logging of such contents and attributes, as illustrated in FIG. 6A, but, as will be explained below, a more expansive listing is logged by the present invention.

In the conventional testing/evaluation 300 shown in FIG. 3, the interaction of user 301 is initiated with at least one browser 302 accessing at least one server 305 via a connection 304. Aside from the feedback questionnaire 306, a logging facility 303, 307 is provided. The logging cycle might include browser-side logs 303 and server-side 307 logs, which represent two distinct avenues of log information.

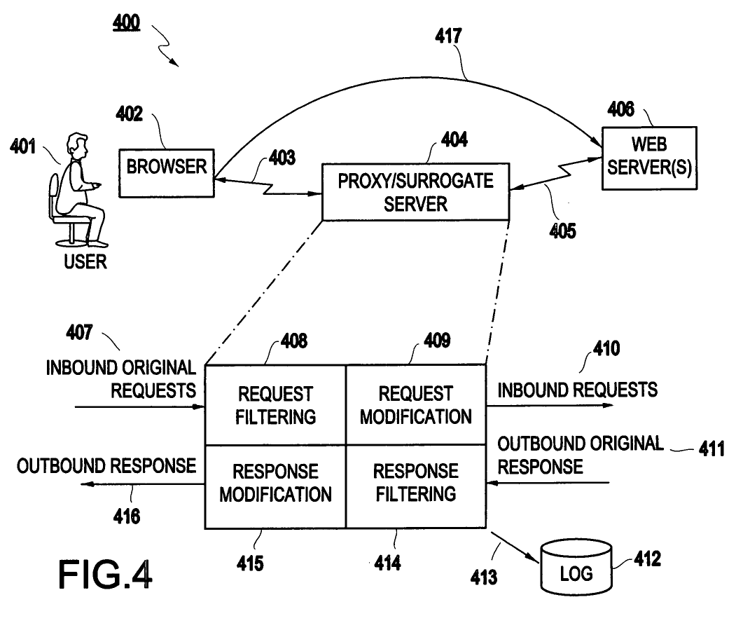

In contrast, FIG. 4 shows an exemplary embodiment 400 of the present invention. A user 401 using browser 402, via some original connection 417, accesses at least one web server 406.

A basic mechanism of the present invention is that all hyperlinks in the initial web page will cause request traffic to be directed via pathway 403 to the proxy/surrogate server 404 included in the exemplary embodiment of the present invention. The inbound original request stream 407 carries the second and subsequent requests to the proxy/surrogate server 404. Proxy/surrogate server 404 would typically be a separate computer running the special application shown in modules 408, 409, 415, 416 in FIG. 4.

One exemplary method to achieve this automatic redirection is to establish a TCP/IP application program to operate as a proxy server 404. A browser must be configured to use the proxy server for every HTTP request. Received requests could be modified before forwarding to the intended HTTP Web server. Responses received by the proxy program would then, after modifications, be returned to the originating browser.

Dialog capture is guaranteed because the browser proxy parameter is adjusted to insure that every request is first given to the proxy server 404. All events may be recorded in a log file.

It is noted that this invention is not limited to using Port 80 for the connection, since any Port can be used. That is, Ports 1080, 1088, 2080 are typical alternative port assignments found in practice.

One exemplary method to do this is to have a program establish and operate a a TCP/IP application to serve as proxy/surrogate server 404 that can accept requests as though it were a web server. This application can forward requests (request streams) to the intended web servers, receive responses and return the responses to the originating client browser. The application applies modifications to the requests and responses as appropriate to the desired results. A key change is that of altering embedded URLs to ensure that requests are first passed back through the surrogate server, since, unlike a browser's proxy modification, there is no other guarantee that requests would be forwarded to the surrogate server.

Thereinafter, application 404 uses the processes 408, 409, 414, 415 shown in FIG. 4 and FIGS. 7-10 to receive the browser request and determine how to modify the request, if needed, forward the request to the “real” or “intended” server (e.g., what the user thinks is the target), and returning the received response, appropriately modified, to the browser.

The application 404 then “waits” for the response from the “intended” server 406, determines how to modify the response 415, if needed, and returns it to the browser 402.

The future inbound original requests 407 are then subject to request filtering 408, wherein some requests are passed directly to the inbound request stream 410 without modification. However, some such requests may be modified 409 before exiting as inbound requests 410. Modifications at this stage might include, for example, aggregation of the user's pattern of other page visits, tempo, and other contextual information.

It is noted at this point that the present invention is not intended as being limited to specific content that might be included in the request modification 409 or to the criteria for excluding some requests via filtering 408, since these aspects and capabilities depend upon specific environments and situations for which the present invention has been implemented.

The inbound requests 410 then make their way via path 405 to appropriate web resources 406, so that an outbound original response 411 can then be generated. Some responses may require no modification. This is determined in the response filtering 414, causing some streams to simply return to the 402, by being passed to the outbound response stream 416. Other responses may be modified in the response modification section 415.

Typical response modifications might include removal, substitution, and generation of pop-ups, but, again, the present invention is not intended as being limited to specific content changes or rules affecting such, since the content changes or change rules are subject to the requirements of the provider of the invention apparatus and is determined by the provider's intended purpose for capturing the user dialogs with the web site.

Logging 413 is potentially performed in all stages of the request and response stream generation. However, the specific detail of how the logging is performed is not particularly relevant to the present invention.

That is, the log 412 might, for example, be a simple journal used only for recording information for later analysis, or it might be a dynamic database that is used to enhance and enrich the versatility of the response modification for truly dynamic responsiveness.

For proxy server operation, the server 404 is guaranteed to manage all web traffic on behalf of the browser regardless of the user's selection of a URL by any means. For surrogate server operation, so long as the user selects URLs from the modified web pages as supplied through the outbound response 416, the server 404 will remain as the pathway for web pages, including those not on the target web server 406.

For example, if a hyperlink on a web page is clicked, the web browser traffic will still flow through the server 404. The interdiction of the server 404 can exemplarily be broken when the user selects a non-associated web server by, for example, one of the following typically methods:
1) manually typing a URL; 2) selecting a previously-saved URL from the browser's history; or 3) selecting a saved URL via a selection menu.

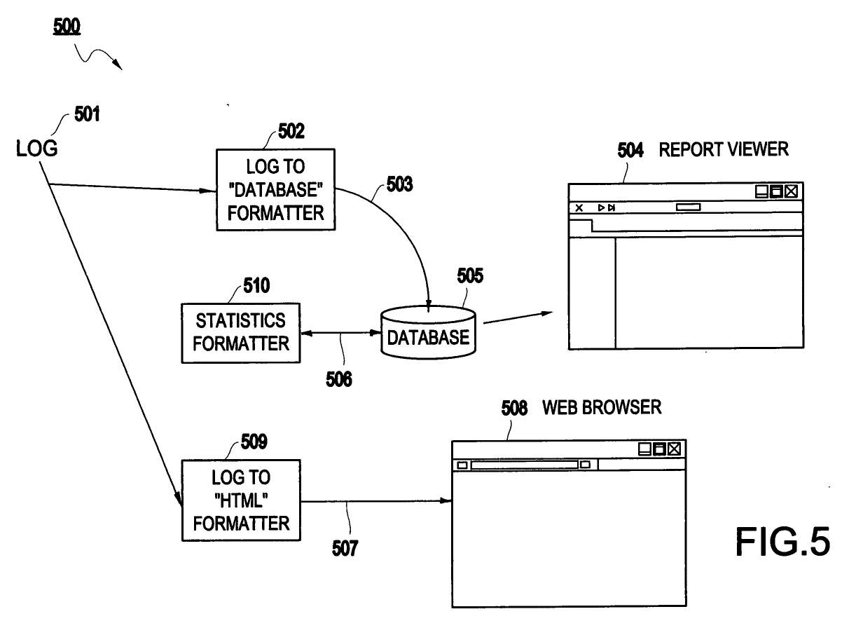

FIG. 5 illustrates exemplarily the real-time monitor and reporting feature 500 for the present invention. Log data 501 can be captured to a database 505 after suitable encoding and arranging by formatter 502. Report viewer 504 allows a user to view logged activity.

Data mining and statistical analysis 510 can be performed on demand or automatically on the database 505, for example, by statistics formatter 510, using path 506. Additionally, formatter 509 can be used to format log data 501 in HTML for up-to-the-minute reviewing via generation of dynamic web pages for presentation via path 507 onto a web browser 508, for real-time or historical observation by analysts.

FIG. 6A shows exemplarily the logging of the present invention, which is similar in concept to logging discussed briefly during the discussion of the conventional methods and shown in FIG. 6. However, in contrast to the logging of the conventional systems, the present invention includes, from a higher perspective, other essential information than that included in the conventional methods. That is, in contrast to conventional methods, the present invention will capture the user's minute-by-minute use of web resources, including visits to “other” web sites.

Moreover, since the present invention requests user comments on an as-needed basis, it also logs such responses in a real-time manner. Therefore, examples of logging by the present invention, additional to conventional logging, includes users' visits to “other” URLs (e.g., user meandering) and “in-situ” comments by the client, although the additional logging capabilities of the present invention is not intended as limited by these examples.

That is, a key aspect of the present invention is that it can capture substantially the full detail (and more preferably the entire detail) of the user's requests, as generated by clicking on hyperlinks, and posting responses on forms. Referring briefly back to FIG. 6A, a record might, for example, contain the date/time, direction, URL, data from forms (including the popup questionnaires), and similar details for any sites visited as a consequence of using the provided hyperlink on any displayed page.

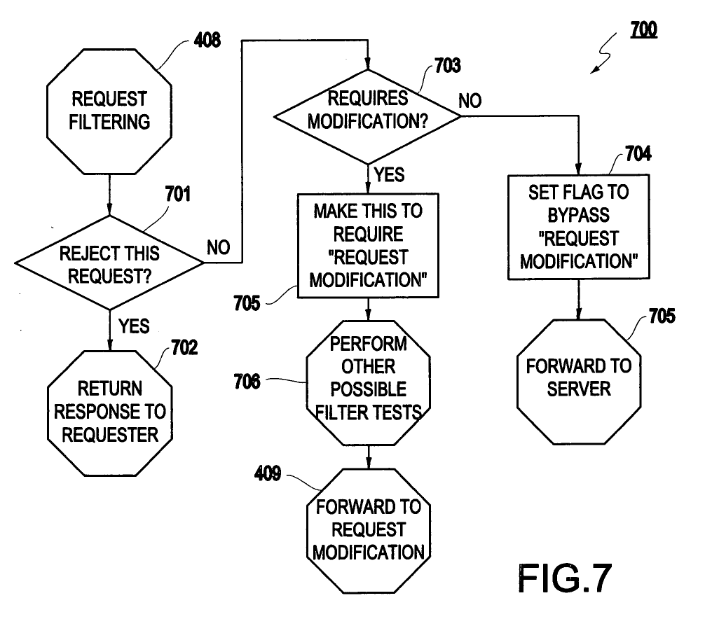

FIG. 7 depicts an exemplary “Request Filtering” module 700 for the invention (reference back to module 408 in FIG. 4). Requests come from the client (e.g., see 407 in FIG. 4). It is possible for any browser to forward a request that is not recognized as served with the Surrogate Server (as is done in the process of “hacking”), and thus can be rejected 701, 702.

That is, since one function of the proxy/surrogate server 404 is that of formulating the URLs returned to the browser 402 during the dialog, the request filtering module 408 of the proxy/surrogate server 404 would easily, in step 701, identify a URL request that had not been formulated as an embedded hyperlink and, thus, reject it. The rejected URLs might also include “stale” URLs that expired over time.

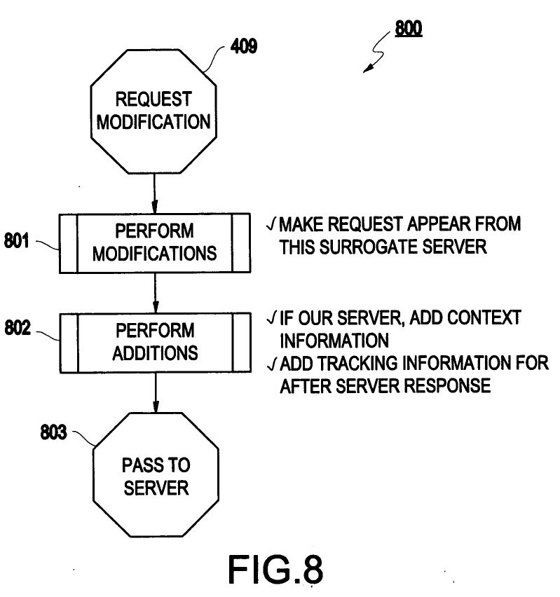

Depending on the source of the request and, optionally, factors of state within the surrogate server, the request can be forwarded directly to the server, bypassing modification, as a default action 703, 704, 705. Otherwise, the request can be marked for action 705, tagged with additional information as it may relate to prior requests and responses 706. If found eligible for modification, it is so marked and forwarded, in step 409, to the process exemplarily shown in FIG. 8.

The present invention is not limited to requiring the application of a prior factor of state as it regards requests. The apparatus of the present invention is not particularly vulnerable to invalid requests and is more robust in responding to legitimate requests by application of the “Request Filtering” module.

FIG. 8 depicts an exemplary “Request Modification” module 800 (e.g., see module 409 in FIG. 4). In step 801, modifications are performed on those requests that are marked for change. The request stream would include the real target server specification in its original URL. The primary change will be to delete the surrogate server portion of the URL, retaining only the portions necessary for forwarding the request to the target web server.

Other changes for requests include, possibly, modifying the source address to make the request appear to be made by the surrogate server, instead of the actual client browser. This change is optional, as the request will be sent by the surrogate server to the web server and, consequently, the returned response will be passed to the originator (e.g., the client browser). The purpose for modifying a request in this way would be to perform multiple accesses for a single user request.

Context information and tracking information can optionally be added, in step 802, to the request stream. This information will remain available for use after the request has been passed to the remote web server(s), in step 803, and returned.

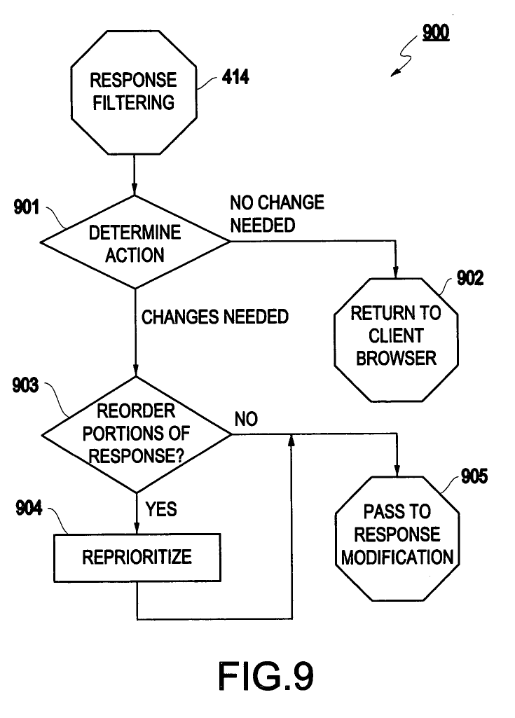

FIG. 9 depicts an exemplary “Response Filtering” module 900 (e.g., see 414 in FIG. 4). The surrogate server 404 establishes the connection with a web server and, thus, has the response stream that is returned from the remote server. The response is combined with any context information and tracking data that was previously added during request processing (e.g., step 8 in FIG. 8). Normally, in step 901, the server response is determined if eligible for modification. If not, the response is transparently passed back, in step 902, to the requesting client browser. If a change is needed, such as reordering some portion of the response in step 903 (e.g., such as moving favored links to favored positions on a web page), the change is executed in steps 904, 905.

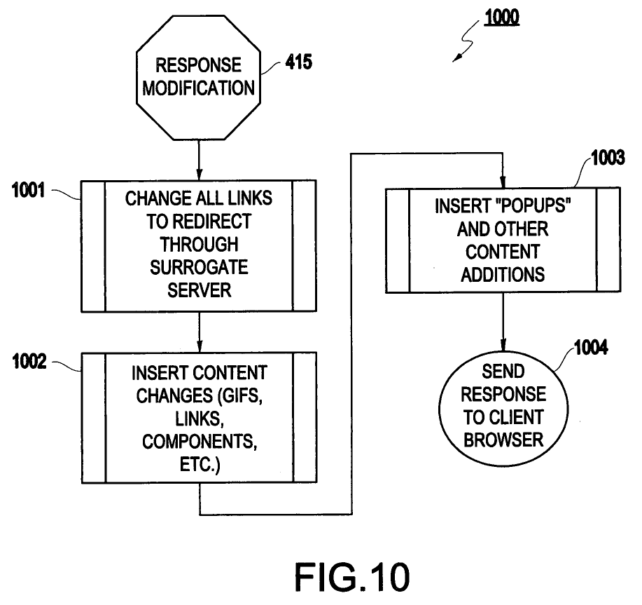

FIG. 10 depicts an exemplary “Response Modification” module 1000 (e.g., see 415 in FIG. 4). All links within the web page, including those that are programmatically produced, are modified in step 1001 to redirect the response to the surrogate server (e.g., a link with the target URL: “http://www.abc.xyz” with “http://surrogate_server.mydomain.com/_www.abc.xyz”).

Another staged change to the response stream might be the insertion, in step 1002, of content changes to alter the appearance of the web page returned. Such changes might include one or more changes to items such as wording, graphics, parameters, and specified content components. In step 1003, popups and other content addition may be included with the response stream transmitted in step 1004, depending on the functional requirements in the implementation of the present invention.

For example, a dynamically generated questionnaire might be placed to permit interrogating the user on a prior response. Such popups may even employ further response dialogs for each user-specified response. Other popups might serve only to post advisory information to the user at the client browser. The present invention is not to be interpreted as being limited in scope to those types of changes listed herein, nor is the present invention to be considered as limited by the particular number of changes that might optionally be applied.

Nor is the present invention intended as being limited to the modification examples provided above, since it should be readily recognized by one of ordinary skill in the art, taking the present application as a whole, that the modifications at this stage would depend upon the specific environment in which the present invention is being implemented. Thus, similar to the modifications at an earlier stage, modifications at this stage may depend upon whether, for example, the present invention is implemented for the purpose of testing a web site versus a purpose of attempting to influence/guide a user in a purchasing scenario.

Thus, having read the discussion above, one of ordinary skill in the art would readily recognize that the present invention provides a method:
to capture dialogs via a common connection point, the surrogate/proxy server;
to filter inbound requests (coming from the experimental subject or user);
to modify content of the user's request;
to direct the user's request to an appropriate web server;
to filter outbound response created by the web server; and
to modify the response before passing it back to the client (user).

One of ordinary skill in the art would also readily recognize from the above discussion that the present invention is an apparatus that allows:
the use of multiple web servers so as to be transparent to the client (user);
the client to use multiple web browser dialogs without encumbrances;
multiple clients, sparsely located in a geographic sense, to concurrently perform an experiment on the effectiveness of a web site;
capture of appropriate logging of the requests and responses for analysis; and
concurrent interviews with users to be conducted.

The present invention also provides a system to avoid the use of a proxy setting in the web browser altogether, by taking original requests and supplying modification to all responses, which keeps requests coming to the surrogate server. It also provides an apparatus to capture log data, annotated with “think time” and captured into instantly usable HTML files (e.g., for presentation to an observer, including presentation in real time), and a detailed database for advanced analysis, either in real time or at some future time.

In terms of the experiment environment discussed earlier, the present invention also provides a method for integrating the user's interview process with his or her active web dialog and a means to capture all non-experiment web dialogs along with those specifically in the experiment, for comprehensive analysis. It should be apparent to one of skill in the art that this interview process is adaptable not only to scenarios of web page testing, but also to web-based purchasing scenarios, as better illustrated by various scenarios below. Moreover, the present invention provides a method so that all of the capabilities described above can be done very economically.

It should also be apparent that the present invention also provides a means of analyzing user interaction with the system, based on such parameters as frequency measures, duration of interaction and content data, although the details of such analyses is not so important and would depend upon the purpose of each analysis. It provides resources for detailed analysis of natural language system errors, thereby providing a basis for improved system iterations and a basis for examining natural language dialog flow, detecting and correcting flaws in dialog, presentation, and back end managers.

The present invention can also provide a basis for predicting and maximizing on the popularity/business impact of sites and links leading to final purchase of products. It can also provide a basis for establishing benchmarks to measure the success of natural language systems, in terms of user satisfaction or dialog completion rate. It can provide a method for simulation of real testing scenario to achieve real and realistic prediction of performance.

Because of these capabilities, benefits, features, and advantages of the present invention, in yet another aspect of the present invention, it is easy to recognize that the methods of the present invention can become the basis for one or more methods of conducting a business or otherwise providing a service.

As non-limiting examples of such possible business or service, an existing business entity might want to use the proxy/substitute server to test, improve, and expand its existing web based operations, using any and/or all of the above-described capabilities. Along this line, it should also be apparent that a business method/service might even be based on one business entity that provides one or more proxy/substitute servers for use by others for this purpose of testing a web site.

It should also be apparent that a business/service method could even be based on providing a service to design and implement for others the various modifications, dialogs, and/or interviews that are now possible with the proxy/substitute server capabilities of the present invention, including the development of software modules that implement these procedures and the provision of servers having the capabilities described herein.

A business/service method could also be based on providing designs and software modules for the analysis of data that is logged in accordance with the concepts described above, in order, for example, to measure effectiveness of a web site, or for executing the analysis thereof.

Moreover, a business/service method might be based on a service that incorporates the concepts of the present invention for designing new web sites and modifying, measuring, and/or improving web sites, whether new or existing.

Although various exemplary business/service methods are mentioned above, it is intended that the present invention additionally covers business/service methods as may be envisioned by one of ordinary skill in the art after reading the present specification.

That is, the present invention's potential in a commercial setting is not at all limited to that of serving as a tool or basis for a service of evaluating and improving web sites, as discussed above. In this aspect of the present invention, it is again mentioned that the present invention has the capability of: 1) totally capturing both directions of a web site dialog, and 2) dynamically modifying any content of the dialog data stream.

The first feature is significant because it provides a complete picture of the dialog, including the user's meandering to other web sites. Because of this complete picture of the dialog (perhaps further enhanced by NLP techniques), the present invention is able to determine and track the state of the user and system, including aspects that might be considered as “psychological” state of the user.

At the beginning of an interaction, the state is uninstantiated, then accumulates characteristics with set attributes that become more refined and possibly paired with other significant attributes. An example of characteristics for specifying a laptop computer might be weight, CPU performance, video, and memory. Attribute for weight might be “lightweight” for portable use, and the CPU could be 2 Gh Pentium 4®. Combined, this could become a characteristic of a mobile, power user.

In turn, one might define combination attributes for such a category. State can include the “system perception” as to the user's implied intentions, and to some extent, the user's confusion. Hence, dialog state is greatly enhanced by detecting the meanderings and history of accesses done by the user and can be simply added to the (natural language) text that that user supplies during an interaction.

Having this psychological state information, the present invention can then dynamically modify the dialog content in a manner that attempts to effectuate the purpose intended by the web site provider for having installed the present invention.

A number of intended purposes can now readily be envisioned, after reading and understanding this specification as a whole. That is, the above-mentioned intent for web site measurement and web site improvement is only one potential purpose. This purpose arose from the experimental scenario, described above, that served as a motivation for developing the present invention. However, the inventors quickly recognized that this experimental scenario is only one of a vast potential of applications possible with the present invention.

After understanding the exemplary following example scenarios, it will be readily apparent that many more applications would be possible, once the flexibility and capability of the present invention to appropriately modify the dialog content are understood.

In a first example, it is assumed that the present invention is incorporated as a component in a proxy server used as an edge server for a university network to reduce bandwidth and traffic for the university network and as an interface to the Internet.

The present invention supplements the conventional proxy server functions by adding the capability to substantially completely track a dialog or even a series (over time) of dialogs for each student or faculty member. As such, since it could have access to the student's schedule of classes, the present invention might be able to add a warning message to the student, should one of her dialogs include visiting a web page concerning an upcoming concert or sports event, that such concert or sports event would conflict with one of her classes. Moreover, should the university have a policy on content (e.g., pornography), the present invention would be able to provide an appropriate warning and filtering to enforce the intended policy.

However, because of its ability to track essentially the entire dialog (e.g., the state of the user), the present invention can provide an additional feature(s) of “enhancement” as appropriate and based on having tracked the two-way dialog essentially completely.

That is, assuming that a student establishes a dialog in which he is searching for information for a research paper on a particular area of art or music, for example. The present invention, having access to the entire dialog (and possibly, utilized NLP techniques in analyzing the dialog), would then be able to enhance the query by adding information for current or upcoming art exhibits or musical events that might be of interest to this student, as based on tracking this dialog and, including, possibly, a number of meanderings to other web sites.

It should be apparent that the present invention executes this enhancement example by using the modification capability discussed in FIG. 10. It should also be apparent that this enhancement need not be implemented by the somewhat intrusive and annoying popups, but, rather could be simply added as a rather unobtrusive additional object in the response stream sent back to the user, such as an additional label or object added to the page or data that the user would expect from her latest request for information.

In another exemplary commercial scenario, the enhancement feature of the present invention might be incorporated as part of an Internet web site. Or, it might be an optional feature in a contract with a server provider to whom a browser-user pays a service fee for having available the modification/enhancement capability of the present invention so that Internet dialogs are completely captured and potentially filtered and/or enhanced.

For example, in a household browser service contract, the parents may find very attractive the ability of the present invention to filter out material considered as being objectionable for children, or selectively filtered for appropriate age categories. The enhancement feature might even be separately contracted as a feature that would provide additional information for enrichment.

For example, the response stream returning to the browser for a child conducting an Internet search for information on stars might be dynamically modified to add a data stream object containing a question asking whether the child would like to contact the NASA web site to see photographs of the Milky Way, possibly along with a second object that presents the NASA URL as a selectable item in the display.

As another example, a business that has a web site and/or uses Internet purchasing or advertising might want to incorporate the present invention modification/enhancement capability to assist potential purchasers to make more informed decisions or otherwise influence purchases. As one scenario, upon contacting a computer vendor web site having the present invention, the proxy/surrogate server would be able to monitor the purchaser's meandering to other computer vendors' web sites and would be able to decipher what products the purchaser seems interested in comparing.

Therefore, as an enrichment of information, the proxy/server might present a listing of potential other products or even web sites that might assist the purchaser to make a decision. The enhancement might even be a comparison of the various products being checked out, as generated by tracking the dialog to the other web sites and noting the characteristics seemingly being checked out by the potential purchaser. And, of course, there is also the potential to attempt to influence a purchaser who seems ready to purchase a competitor's product. This might be done, for example, by adding information that points out the advantages of your product over those of the competitors. It should be readily recognized that the present invention, in appropriate scenarios, would be able to attempt some automatic negotiation or “final offers”.

Moreover, because the present invention has the capability to log a complete dialog, it should be readily recognized that the present invention could be used, not only to track the interactions of a user for one dialog, but that the dialogs from one user could be stored and tracked over time for a series of dialogs. This historical dialog tracking could additionally be analyzed, again possibly using NLP techniques to better determine context, to determine enhancements appropriate for a specific user, as based on previous dialogs in addition to the current dialog.

It is also noted that the modifications possible with the present invention would often include rather subtle modifications, in contrast to the quite obtrusive and annoying popups that have become common in web page design. That is, as previously mentioned, the present invention might simply add another object such as a company logo or URL that was not present in the original response stream, thereby cleverly and unobtrusively “redecorating” the contents.

Thus, using the above examples, the present invention modification feature includes a number of potential methods to modify the dialog data stream:
1. An element can be modified. For example, by changing a non-related URL to add a label, the present invention is able to ensure that the dialog with that URL is funneled through the present invention proxy/surrogate server, rather than directly between the browser and the URL;
2. An element can be removed from the response stream, but the user can take steps to re-instate the element or objects. For example, a content filter might be implemented as being retractable by entering a password or some other user selection;
3. An element can be removed from the response stream and the element or objects cannot be re-instated by the user;
4. An element can be replaced by another element; and
5. A totally new, additional element can be added to the response stream.

As yet another example in which the features and capabilities of the present invention might be used in a commercial application, it would be straightforward to use the two-way dialog capture and logging to monitor purchase queries to a client web site and track the potential purchaser upon having contacted the web site, for the duration of the dialog.

In reality, it is quite possible that the potential purchaser will ultimately make a purchase through a competitor's web site, rather than purchasing a product from the client's web site. In this case, since the client web server has been accessed, the proxy/surrogate server of the present invention will have been invoked and the subsequent dialog that includes the purchase of the competitor's product will be tracked and logged.

Therefore, by analyzing the details of the purchaser's dialog, it might be possible to conclude, or at least surmise, why the potential purchaser ultimately went to the competitor, rather than purchase from the client. Thus, in this scenario, the present invention would be a tool to collect and analyze why potential customers are not purchasing products from a client. It should also be readily recognized that a marketing consultation service could be based upon this monitoring and analysis of purchases, including purchases that are completed by contacting other web sites than the one associated with the present invention.

It is also noted here that, although the present invention cannot monitor the contents of the dialog if encryption is used for the data (e.g., in certain phases of online purchasing transactions wherein data is secured by encryption), it is still possible to monitor the progress of the secure portions of the transaction, including, for example, such parameters as the time spent in the secured phase of the transaction.

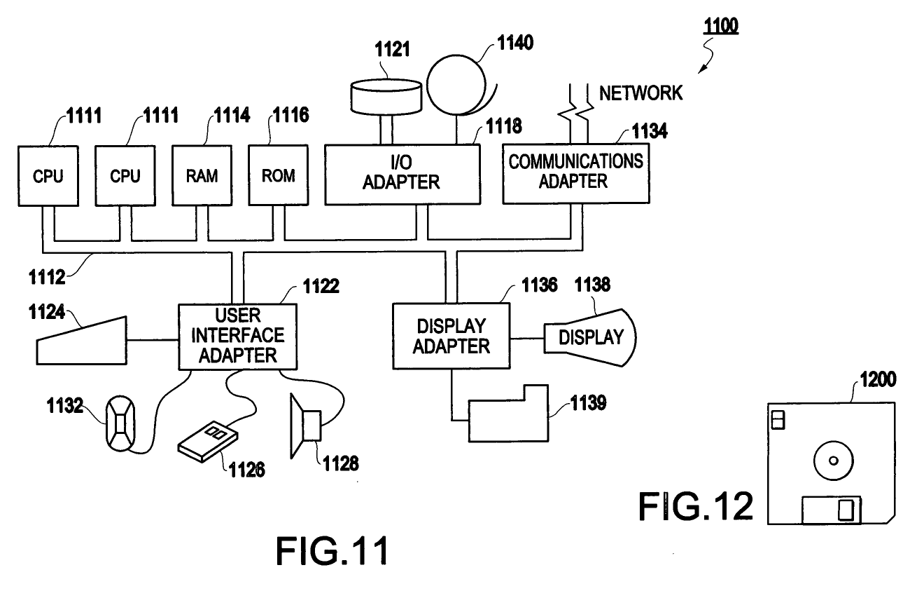

In yet another aspect of the present invention, FIG. 11 illustrates a typical hardware configuration of an information handling/computer system 1100 in accordance with the invention and which preferably has at least one processor or central processing unit (CPU) 1111.

The CPUs 1111 are interconnected via a system bus 1112 to a random access memory (RAM) 1114, read-only memory (ROM) 1116, input/output (I/O) adapter 1118 (for connecting peripheral devices such as disk units 1121 and tape drives 1140 to the bus 1112), user interface adapter 1122 (for connecting a keyboard 1124, mouse 1126, speaker 1128, microphone 1132, and/or other user interface device to the bus 1112), a communication adapter 1134 for connecting an information handling system to a data processing network, the Internet, an Intranet, a personal area network (PAN), etc., and a display adapter 1136 for connecting the bus 1112 to a display device 1138 and/or printer 1139 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is additionally directed to a programmed product, comprising signal-bearing media tangibly embodying a program of machine-readable instructions executable by a digital data processor incorporating the CPU 1111 and hardware above, to perform the method of the invention.

This signal-bearing media may include, for example, a RAM contained within the CPU 1111, as represented by the fast-access storage for example. Alternatively, the instructions may be contained in another signal-bearing media, such as a magnetic data storage diskette 1200 (FIG. 12), directly or indirectly accessible by the CPU 1111.

Whether contained in the diskette 1200, the computer/CPU 1111, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

While the invention has been described in terms of exemplary embodiments, those skilled in the art will recognize that the invention can be practiced with modification within the spirit and scope of the appended claims.

Further, it is noted that Applicants' intent is to encompass equivalents of all claim elements, even if amended later during prosecution.

1. A method of enhancing a dialog with a web server, said method comprising:
determining a dialog state by comprehensively capturing a dialog with said web server.

2. The method of claim 1, further comprising:
modifying said dialog, as based on said determining said state.

3. The method of claim 1, said determining a dialog state further comprising:
analyzing a content of said dialog.

4. The method of claim 3, said determining a dialog state further comprising:
analyzing a context of said content.

5. The method of claim 4, wherein said context analyzing optionally comprises natural language processing.

6. The method of claim 1, wherein said comprehensively capturing said dialog comprises:
causing an inbound request from said browser to be directed to an intermediary; and
causing an outbound response bound for said browser to be first directed to said intermediary.

7. The method of claim 6, wherein said causing said inbound request and said outbound response to be directed to said intermediary further causes a plurality of inbound requests and a plurality of outbound responses to be directed to said intermediary.

8. The method of claim 1, further comprising:
modifying a content of said dialog.

9. The method of claim 8, wherein said modifying comprises at least one of:
modifying an existing element from one of an inbound request and an outbound response;
removing an element from said outbound response, wherein an action at said browser allows said element to be re-instated;
removing an element from said outbound response, wherein said removed element cannot be re-instated by any action at said browser;
replacing a first element from one of said inbound request and said outbound response by a second element; and
adding a new element to one of said inbound request and said outbound response.

10. The method of claim 9, wherein said modification comprises inserting a uniform resource locator (URL) to allow one of:
said user to select a second, non-related web server;
an inbound request for said user to be sent to a new target web server;
an inbound request from said user to be directed to said web site and a response thereof to be sent to said intermediary;
an outbound response from said web site to be directed to said user; and
an outbound response from one of said second non-related web server and said new target web server to be directed to said intermediary;

11. The method of claim 9, wherein said dialog continues to be captured when said second, non-related web server is selected by said user and when said requests are sent to said new target web server.

12. The method of claim 2, wherein said modifying performs at least one of:
improving an efficiency of said web site;
censoring information to said user;
providing a warning to said user;
asking said user to explain at least one of an action and a mental state;
providing additional information;
providing additional information that can be selected by said user;
indicating a second, non-related web site to be selectable by said user; and
providing additional information to attempt to influence a decision by said user.

13. The method of claim 1, wherein said dialog continues to be captured when a user selects another web site.

14. An apparatus for enhancing a dialog with a web server, said apparatus comprising:
a dialog capture module to comprehensively capture a dialog between said web server and a browser.

15. The apparatus of claim 14, further comprising:
an analyzer to determine a state of a user involved in said dialog.

16. The apparatus of claim 14, further comprising:
a module to modify said dialog.

17. The apparatus of claim 16, wherein said module to modify performs a modification of said dialog based on a state of said dialog.

18. The apparatus of claim 14, wherein said dialog continues to be captured if a user selects another web site.

19. A signal-bearing medium tangibly embodying a program of machine-readable instructions executable by a digital processing apparatus to perform a method of enhancing a dialog with a web server, said method comprising:
comprehensively capturing a dialog between said web server and a browser.

20. The signal-bearing medium of claim 19, said method further comprising:
determining a state of a user involved in said dialog.

21. The signal-bearing medium of claim 19, said method further comprising:
modifying said dialog.

22. The signal-bearing medium of claim 20, said method further comprising:
modifying said dialog based on said state.

23. The signal-bearing medium of claim 20, wherein said determining said state comprises:
analyzing a context of a content of said dialog.

24. A method of providing a service, said method comprising at least one of:
operating an intermediary web service to comprehensively capture a dialog with a web site, wherein said dialog is captured when an initial access request from a browser is received by said web site and a subsequent dialog between said web site and said browser is directed through said intermediary web service;
operating a web site that requests said intermediary web service to capture said dialog;
analyzing information in said dialog;
modifying a content of said dialog;
designing a computer program module to be incorporated in said intermediary web service for said dialog capturing;
designing a computer program module to be used in said analyzing; and
designing a computer program module to be used in said modifying content of said dialog.

25. A system for capturing a dialog with a web server, said system comprising:
means for receiving, from a browser, an initial access request to said web server;
means for comprehensively capturing a dialog between said browser and said web server based on said initial access request, wherein said capturing includes capturing an inbound request from said browser and an outbound response from said web server in response to said inbound request.

26. The system of claim 25, further comprising:
means for determining a state of a user involved in said dialog.

27. A method of providing a service, said method comprising at least one of:
operating a web server so that, upon receiving an initial access request to said web server, a subsequent dialog associated with said initial access is directed through an intermediary established to capture said dialog;
operating a web server in the manner of said intermediary;
at least one of developing, producing, selling, transmitting via said web server, and receiving, via a network, a set of machine-readable instructions executable by a digital processing apparatus to perform a method of capturing a dialog on said network using said intermediary;
at least one of developing, producing, selling, transmitting via said network, and receiving via said network a set of machine-readable instructions executable by a digital processing apparatus to perform a method of at least one of filtering and modifying a dialog being processed through said intermediary;
at least one of receiving, displaying, storing, analyzing, and receiving an analysis of a dialog captured using said intermediary;
at least one of developing, producing, selling, transmitting via said network, receiving via said network, and executing a set of machine-readable instructions executable by a digital processing apparatus to at least one of receive, display, store, and analyze a dialog captured using said intermediary.

28. The method of claim 27, wherein said capturing a dialog provides a method for at least one of:
evaluating a website comprising said web server;
improving an efficiency of said website;
determining a state of said user;
influencing at least one of an action and a selection made by said user; and
conducting an interview with said user.

29. A method for deploying computing infrastructure, comprising integrating computer-readable code into a computing system, wherein the code in combination with the computing system is capable of performing the method of claim 1.

30. A method of enhancing a dialog with a web server, said method comprising:
comprehensively capturing a dialog with said web server.
